(19) United States
(12) Patent Application Publication
(10) Pub. No.: US 2012/0272128 A1
(43) Pub. Date: Oct. 25, 2012

(54) MOBILE TERMINAL APPARATUS

(75) Inventors: Keiji TAKAKU, Toyota-shi (JP); Koji GOTO, Osaka-shi (JP); Shinji YOSHIKAWA, Yao-shi (JP)

(73) Assignee: KYOCERA CORPORATION, Kyoto (JP)

(21) Appl. No.: 13/403,892

(22) Filed: Feb. 23, 2012

(30) Foreign Application Priority Data
Feb. 24, 2011 (JP) 2011-038550

(51) Int. Cl. G06F 3/041; G06F 17/00

(52) U.S. Cl. 715/205; 345/173

(57) ABSTRACT

A mobile terminal apparatus is provided. The apparatus includes a first display section, a second display section aligned with the first display section, and a control section configured to control display of the first and second display sections. The control section is configured to display, on at least one of the first and second display sections, a key object to switch a display mode of the first and second display sections. The control section is configured to switch the display mode between a first mode where an execution screen for one application is displayed on the first and second display sections and a second mode where an execution screen for one of two applications is displayed on the first display section and an execution screen for the other of the two applications is displayed on the second display section, based on an operation to the key object.

### CROSS-REFERENCE TO RELATED APPLICATION

This application claims priority from Japanese Patent Application No. 2011-038550, filed on Feb. 24, 2011, the entire subject matter of which is incorporated herein by reference.

### BACKGROUND OF THE INVENTION

1. Field of the Invention

The present invention relates to a mobile terminal apparatus, such as a mobile phone, a PDA (Personal Digital Assistant), or a tablet PC.

2. Description of the Related Art

There has been proposed a mobile terminal apparatus such as a mobile phone which is provided with two displays. For example, two displays are configured to be aligned with each other (for example, refer to JP-A-Hei.9-305262).

In a mobile terminal apparatus, however, a plurality of application programs (hereinafter, simply referred to as “applications”) may be executed in parallel. When the mobile terminal apparatus has two displays as described above, execution screens of two executed applications can be displayed in the two displays, respectively. Hereinafter, this display mode is referred to as a “two-screen display”.

On the other hand, an execution screen of one executed application may be displayed on one large display surface obtained by combining display surfaces of the two displays. Hereinafter, this display mode is referred to as a “full-screen display”.

In the above configuration, the convenience for the user may be significantly improved if a display mode can be easily switched between the two-screen display and the full-screen display.

### SUMMARY OF THE INVENTION

The present invention has been made in view of the above circumstances, and an aspect of the present invention provides a mobile terminal apparatus capable of easily switching its display mode between two-screen display and full-screen display.

According to an illustrative embodiment of the present invention, there is provided a mobile terminal apparatus comprising: a first display section; a second display section aligned with the first display section; and a control section configured to control display of the first and second display sections. The control section is configured to display, on at least one of the first and second display sections, a key object to switch a display mode of the first and second display sections. The control section is configured to switch the display mode between a first mode where an execution screen for one application is displayed on the first and second display sections and a second mode where an execution screen for one of two applications is displayed on the first display section and an execution screen for the other of the two applications is displayed on the second display section, based on an operation to the key object.

In the above mobile terminal apparatus, the key object may include a first key object corresponding to the first display section and a second key object corresponding to the second display section. In this case, when the first key object is operated in a state where the display mode is the second mode, the control section is configured to display on the first and second display sections an execution screen for an application whose execution screen has been displayed on the first display section in the second mode. When the second key object is operated in a state where the display mode is the second mode, the control section is configured to display on the first and second display sections an execution screen for an application whose execution screen has been displayed on the second display section in the second mode.

In the above mobile terminal apparatus, when the key object is operated for switching from the first mode to the second mode, the control section may be configured to display on the second display section an execution screen for an application executed in a background.

In the above mobile terminal apparatus, when the key object is operated for switching from the first mode to the second mode, the control section may be configured to start a pre-set application and displays on the second display section an execution screen for the started pre-set application if no application is executed in the background. Alternatively, when the key object is operated for switching from the first mode to the second mode, the control section may be configured to display on the second display section an execution screen for an application which is related to a latest operation in an operation history if a plurality of applications are executed in the background.

The above mobile terminal apparatus may further comprise a detection section configured to detect an input on the first and second display sections. In this case, the detection section is configured to detect an input corresponding to an operation to the key object display on the at least one of the first and second display sections.

In the above mobile terminal apparatus, the control section may be configured to display the key object when the detection section detects an input corresponding to a predetermined display operation in a state where the key object is not displayed. For example, when the detection section detects a movement of an input position, the control section may be configured to display the key object as determining that the predetermined display operation is detected.

In the above mobile terminal apparatus, in a state where a hyperlink is set on an execution screen for an application displayed on the first and second display sections in the first mode, the control section may be configured to switch the display mode from the first mode to the second mode and display on the second display section an execution screen for an application started based on the hyperlink when the detection section detects an input corresponding to an operation on the hyperlink.

The above mobile terminal apparatus may further comprise a changing section configured to change between a first state where one of the first and second display sections is exposed to an outside and a second state where both the first and second display sections are exposed to the outside. In this case, the control section is configured to delete the key object when the second state is changed into the first state in a state where the key object is displayed.

The above mobile terminal apparatus may further comprise a changing section configured to change between a first state where one of the first and second display sections is exposed to an outside and a second state where both the first and second display sections are exposed to the outside, and a storage section. In this case, the control section is configured to store the display mode at the time of the second state in the storage section when the second state is changed into the first state, and configured to control the first and second display sections to become the display mode stored in the storage section when the first state is changed into the second state.

According to another illustrative embodiment of the present invention, there is provided a non-transitory computer-readable medium having a computer program stored thereon and readable by a computer of a mobile terminal apparatus including a first display section and a second display section aligned with the first display section, the computer program, when executed by the computer, causing the computer to perform operations comprising: displaying a key object to switch a display mode of the first and second display sections; and switching the display mode between a first mode where an execution screen for one application is displayed on the first and second display sections and a second mode where an execution screen for one of two applications is displayed on the first display section and an execution screen for the other of the two applications is displayed on the second display section, based on an operation to the key object.

According to a further illustrative embodiment of the present invention, there is provided a method for controlling a mobile terminal apparatus including a first display section and a second display section aligned with the first display section, the method comprising: displaying a key object to switch a display mode of the first and second display sections; and switching the display mode between a first mode where an execution screen for one application is displayed on the first and second display sections and a second mode where an execution screen for one of two applications is displayed on the first display section and an execution screen for the other of the two applications is displayed on the second display section, based on an operation to the key object

According to the above configuration, it is possible to provide a mobile terminal apparatus capable of easily switching its display mode between a two-screen display and a full-screen display.

The effect or significance of the present invention will become more apparent by the following explanation of an illustrative embodiment. However, the following illustrative embodiment is just an example when implementing the present invention, and the present invention is not limited to the illustrative embodiment described below at all.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 is a view showing the configuration of a mobile phone according to an illustrative embodiment;

FIG. 2 is a view for explaining an operation for changing the mobile phone from a closed state to an open state in the illustrative embodiment;

FIG. 3 is a block diagram showing the entire configuration of the mobile phone according to the illustrative embodiment;

FIGS. 4A and 4B are views showing a state where a launcher screen is displayed on first and second display surfaces and an application is executed by an operation on the launcher screen in the illustrative embodiment;

FIG. 5 is a flow chart showing the procedure of display control for switching the display mode from a full-screen display to a two-screen display in the illustrative embodiment;

FIG. 6 is a view showing a transition state of a screen display when the display control shown in FIG. 5 related to the illustrative embodiment is executed;

FIG. 7 is a flow chart showing the procedure of display control for switching the display mode from a two-screen display to a full-screen display in the illustrative embodiment;

FIG. 8 is a view showing a transition state of a screen display when the display control shown in FIG. 7 related to the illustrative embodiment is executed;

FIG. 9 is a flow chart showing the procedure of display control for switching the display mode from a full-screen display to a two-screen display based on an operation on a link image in the illustrative embodiment;

FIG. 10 is a view showing a transition state of a screen display when the display control shown in FIG. 9 related to the illustrative embodiment is executed;

FIGS. 11A and 11B are flow charts showing display switching control when the mobile phone according to the illustrative embodiment transitions from the open state to the closed state and display switching control when the mobile phone transitions from the closed state to the open state, respectively;

FIGS. 12A and 12B are views showing transition states of screen display when the display switching control shown in FIGS. 11A and 11B related to the illustrative embodiment is executed, respectively;

FIG. 13 is a flow chart showing the procedure of display control for switching the display mode from a full-screen display to a two-screen display based on an operation on a link image in the closed state in the illustrative embodiment;

FIG. 14 is a view showing a transition state of screen display when the display control shown in FIG. 13 related to the illustrative embodiment is executed;

FIG. 15 is a flow chart showing display switching control when an operation on a link image is performed when the display mode is a two-screen display in the illustrative embodiment; and

FIGS. 16A and 16B are views showing a transition state of screen display when the display switching control shown in FIG. 15 related to the illustrative embodiment is executed.

### DETAILED DESCRIPTION OF THE INVENTION

Hereinafter, illustrative embodiments of the present invention will be described with reference to the accompanying drawings.

<Configuration of a Mobile Phone>

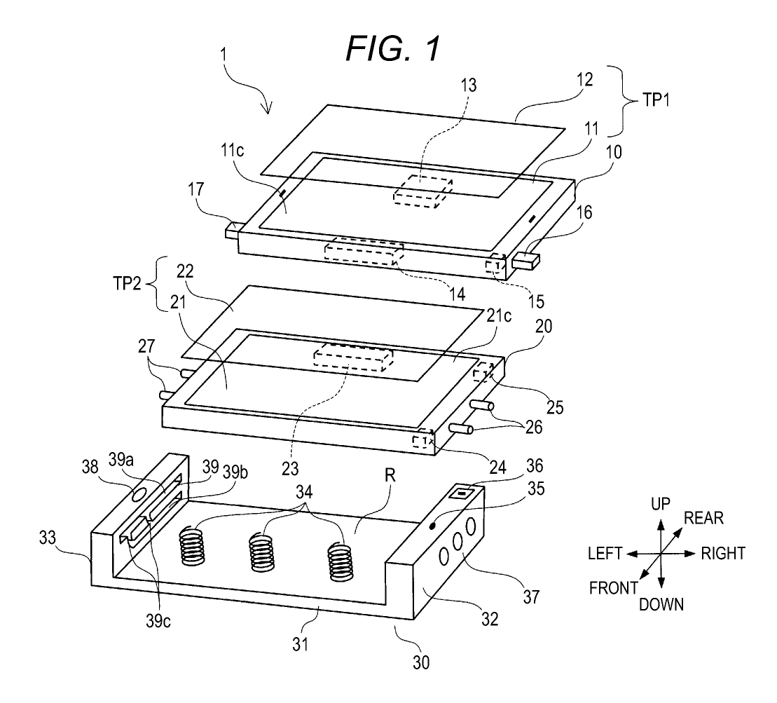

FIG. 1 is an exploded perspective view showing the configuration of a mobile phone 1. The mobile phone 1 includes a first cabinet 10, a second cabinet 20, and a holder 30 which holds the first and second cabinets 10 and 20.

The first cabinet 10 has a horizontally long rectangular parallelepiped shape. A first touch panel TP1 is disposed in the first cabinet 10. The first touch panel TP1 includes a first display 11 and a first touch sensor 12. The surface of the first touch panel TP1 is covered with a protective cover (not shown).

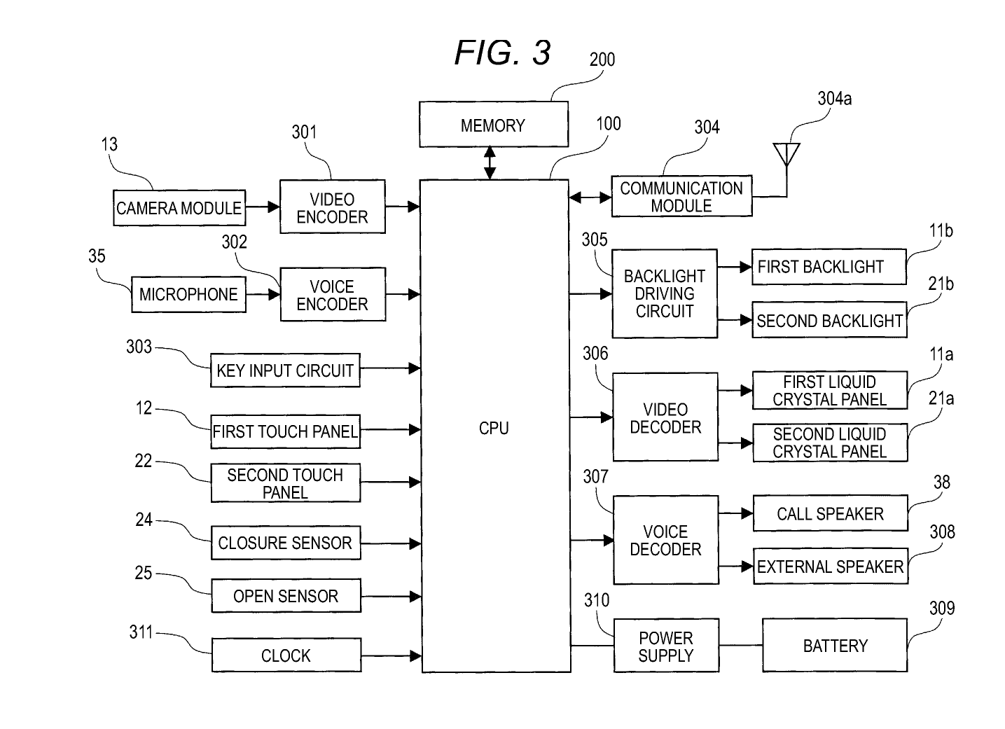

The first display 11 is formed by a first liquid crystal panel 11a and a first backlight 11b for illuminating the first liquid crystal panel 11a (refer to FIG. 3). A first display surface 11c is provided at the top surface of the first liquid crystal panel 11a, and an image (screen) is displayed on the first display surface 11c. The first backlight 11b includes one or a plurality of light sources. The first touch sensor 12 is disposed on the first display 11 so as to overlap the first display 11.

The first touch sensor 12 detects an input on the first display 11. The first touch sensor 12 is a transparent rectangular sheet, and covers the first display surface 11c of the first display 11. The first touch sensor 12 includes first and second transparent electrodes arrayed in a matrix. The first touch sensor 12 detects a position on the first display surface 11c, which is in contact with the user, by detecting a change in electrostatic capacitance between these transparent electrodes and outputs a position signal corresponding to the position. Moreover, in the present illustrative embodiment, the situation when user touches the first display surface 11c includes not only that user completely touches the first display surface 11c with a finger or a touch member, such as a pen, but also that the user approaches the first display surface 11c.

A user can perform various kinds of operations, such as “tap”, “slide”, “flick”, and “long tap”, on the first display surface 11c by touching the first display surface 11c with a finger or the like. Here, “tap” is an operation in which a user touches the first display surface 11c lightly with a touch member or a finger, and also means an operation being away from the first display surface 11c shortly after touching the first display surface 11c with a touch member or a finger. “Slide” means an operation in which a user moves a touch member or a finger while the touch member or the finger is in contact with the first display surface 11c. “Flick” means an operation in which a user strokes the first display surface 11c quickly with a touch member or a finger, and refers to an operation in which a user moves by a predetermined distance or more within a short time while the touch member or the finger is in contact with the first display surface 11c. “Long tap” means an operation in which a user is in continuous contact with the same position of the first display surface 11c for a predetermined time (long time compared with “tap”) with a touch member or a finger.

In the first cabinet 10, a camera module 13 is disposed at a position slightly behind the middle. A lens window (not shown) for capturing a subject image in the camera module 13 is provided at the bottom surface of the first cabinet 10.

Moreover, in the first cabinet 10, a magnet 14 is disposed at the middle position near the front surface and a magnet 15 is disposed in the right front corner.

In addition, protruding sections 16 and 17 are provided on the right and left side surfaces of the first cabinet 10.

The second cabinet 20 has a horizontally long rectangular parallelepiped shape, and has approximately the same shape and size as the first cabinet 10. A second touch panel TP2 is disposed in the second cabinet 20. The second touch panel TP2 includes a second display 21 and a second touch sensor 22. The surface of the second touch panel TP2 is covered with a protective cover (not shown).

The second display 21 is formed by a second liquid crystal panel 21a and a second backlight 21b for illuminating the second liquid crystal panel 21a (refer to FIG. 3). A second display surface 21c is provided at the surface of the second liquid crystal panel 21a, and an image (screen) is displayed on the second display surface 21c. The second backlight 21b includes one or a plurality of light sources. The second touch sensor 22 is disposed on the second display 21 so as to overlap the second display 21.

The first and second displays 11 and 21 may also be formed by other display devices, such as organic EL.

The second touch sensor 22 detects an input on the second display 21. The configuration of the second touch sensor 22 is the same as that of the first touch sensor 12. A user can perform various kinds of operations, such as “tap”, “slide”, “flick”, and “long tap”, on the second display surface 21c by touching the second display surface 21c with a finger or the like.

In the second cabinet 20, a magnet 23 is disposed at the middle position near the rear surface. The magnet 23 and the magnet 14 of the first cabinet 10 are configured to attract each other in an open state to be described later. In addition, if the magnetic force of one of the magnets 14 and 23 is sufficiently large, the other magnet may be replaced with a magnetic body.

In the second cabinet 20, a closure sensor 24 is disposed in the right front corner and an open sensor 25 is disposed in the right rear corner. For example, each of these sensors 24 and 25 is formed by a hall IC and outputs a detection signal in response to the magnetic force of the magnet 15. In a closed state to be described later, an ON signal is output from the closure sensor 24 since the magnet 15 of the first cabinet 10 approaches the closure sensor 24. On the other hand, an ON signal is output from the open sensor 25 in an open state since the magnet 15 of the first cabinet 10 approaches the open sensor 25.

In addition, two shafts 26 and 27 are provided at both side surfaces of the second cabinet 20.

The holder 30 is formed by a bottom plate 31, a right holding section 32 formed at the right end of the bottom plate 31, and a left holding section 33 formed at the left end of the bottom plate 31.

Three coil springs 34 are aligned in the left and right direction in the bottom plate 31. These coil springs 34 are in contact with the bottom surface of the second cabinet 20 in a state where the second cabinet 20 is fixed to the holder 30, so that the force for pressing upward against the second cabinet 20 is given.

A microphone 35 and a power key 36 are disposed on the upper surface of the right holding section 32. A speaker 38 is disposed on the upper surface of the left holding section 33.

A plurality of operation keys 37 which are hard keys are disposed on the outer side surface of the right holding section 32.

A guide groove 39 is formed on the internal side surfaces of the right holding section 32 and the left holding section 33 (the guide groove 39 provided only at the side of the left holding section 33 is shown). The guide groove 39 is configured to include an upper groove 39a, a lower groove 39b, and two vertical grooves 39c. The upper groove 39a and the lower groove 39b extend in the front and back direction, and the vertical grooves 39c extend up and down so as to connect the upper groove 39a and the lower groove 39b to each other.

When assembling the mobile phone 1, the shafts 26 and 27 are inserted in the lower groove 39b of the guide groove 39, and the second cabinet 20 is disposed in a housing region R of the holder 30. The protruding sections 16 and 17 are inserted in the upper groove 39a of the guide groove 39, the first cabinet 10 is disposed on the second cabinet 20, and the first cabinet 10 is housed in the housing region R of the holder 30.

In this way, the first and second cabinets 10 and 20 are housed in the housing region R surrounded by the bottom plate 31, the right holding section 32, and the left holding section 33 in a state where the first and second cabinets 10 and 20 overlap up and down. In this state, the first cabinet 10 is guided to the upper groove 39a, so that the first cabinet 10 can slide in the front and rear direction. The second cabinet 20 is guided to the lower groove 39b, so that the second cabinet 20 can slide in the front and rear direction. In addition, when the second cabinet 20 moves forward and the shafts 26 and 27 reach the vertical grooves 39c, the second cabinet 20 is guided to the vertical grooves 39c, so that the second cabinet 20 can slide up and down.

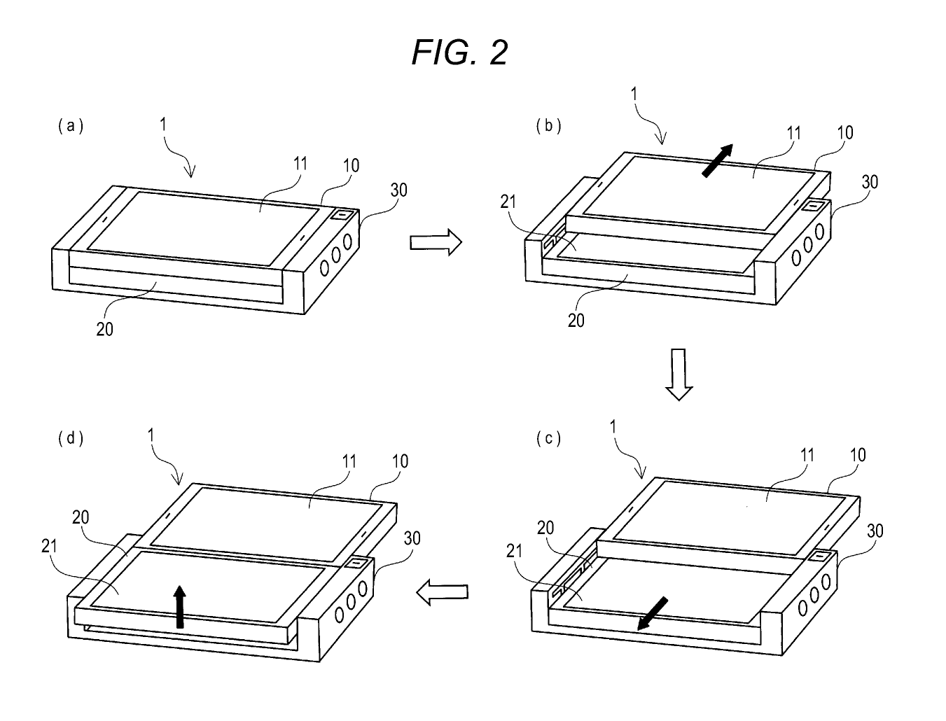

FIG. 2 is a view for explaining an operation for changing the mobile phone 1 from the closed state (an example of a first state) to the open state (an example of a second state).

In the closed state shown in FIG. 2(a), the first cabinet 10 overlaps the second cabinet 20, and the mobile phone 1 is folded. The second display surface 21c is hidden by the first cabinet 10, and only the first display surface 11c is exposed to the outside.

The first cabinet 10 moves rearward in a direction of the arrow shown in FIG. 2(b), and the second cabinet 20 is pulled out forward in a direction of the arrow shown in FIG. 2(c). When the second cabinet 20 does not completely overlap the first cabinet 10, the shafts 26 and 27 shown in FIG. 1 move to the vertical groove 39c. Then, the shafts 26 and 27 move along the vertical groove 39c, so that the second cabinet 20 can move up and down. In this case, the second cabinet 20 rises due to the elastic force of the coil springs 34 and the attractive force of the magnets 14 and 23.

As shown in FIG. 2(d), the first and second cabinets 10 and 20 are aligned in a state where they are in close contact with each other, so that the second display surface 21c of the second cabinet 20 has the same height as the first display surface 11c. As a result, the mobile phone 1 is changed to the open state. In the open state, the first and second cabinets 10 and 20 are horizontally aligned, so that both the first and second display surfaces 11c and 21c are exposed to the outside.

FIG. 3 is a block diagram showing the entire configuration of the mobile phone 1. The mobile phone 1 of the present illustrative embodiment includes a CPU 100, a memory 200, a video encoder 301, a voice encoder 302, a key input circuit 303, a communication module 304, a backlight driving circuit 305, a video decoder 306, a voice decoder 307, an external speaker 308, a battery 309, a power supply 310, and a clock 311 in addition to the above-described components.

The camera module 13 has an imaging device, such as a CCD. The camera module 13 digitizes an imaging signal output from the imaging device, performs various kinds of correction processing, such as gamma correction, on the imaging signal, and outputs the result to the video encoder 301. The video encoder 301 performs encoding processing on the imaging signal from the camera module 13 and outputs the result to the CPU 100.

The microphone 35 converts the collected voice into a voice signal and outputs the result to the voice encoder 302. The voice encoder 302 converts the analog voice signal from the microphone 35 into a digital voice signal and also performs encoding processing on the digital voice signal and outputs the result to the CPU 100.

The key input circuit 303 outputs to the CPU 100 an input signal corresponding to each key when the power key 36 or the operation key 37 is pressed.

The communication module 304 converts various kinds of data (voice data, image data, and the like) from the CPU 100 into radio signals and transmits the data to a base station through an antenna 304a. In addition, the communication module 304 converts the radio signals received through the antenna 304a into various kinds of data and outputs the data to the CPU 100.

The backlight driving circuit 305 supplies a driving signal, which corresponds to a control signal from the CPU 100, to first and second backlights 11b and 21b. The first backlight 11b is lit by the driving signal from the backlight driving circuit 305 and illuminates the first liquid crystal panel 11a. The second backlight 21b is lit by the driving signal from the backlight driving circuit 305 and illuminates the second liquid crystal panel 21a.

The video decoder 306 converts the image data from the CPU 100 into image signals, which can be displayed on the first and second liquid crystal panels 11a and 21a, and outputs them to the first and second liquid crystal panels 11a and 21a.

The first liquid crystal panel 11a displays an image corresponding to the image signal on the first display surface 11c. The second liquid crystal panel 21a displays an image corresponding to the image signal on the second display surface 21c.

The voice decoder 307 performs decoding processing on the voice signal from the CPU 100 and sound signals of various notification sounds, such as ring tones or alarm sounds, and converts these signals into an analog voice signal and sound signals. The speaker 38 reproduces the voice signal from the voice decoder 307 as a voice. The external speaker 308 reproduces the sound signals from the voice decoder 307 as notification sounds.

The battery 309 supplies electric power to the CPU 100 or each section other than the CPU 100 and is formed as a secondary battery. The battery 309 is connected to the power supply 310.

The power supply 310 converts the voltage of the battery 309 into a voltage with an amount necessary for each section and supplies it to each section. In addition, the power supply 310 supplies electric power, which is supplied through an external power supply (not shown), to the battery 309 in order to charge the battery 309.

The clock 311 measures time and outputs a signal corresponding to the measured time to the CPU 100.

The memory 200 includes a ROM and a RAM. A control program for giving a control function to the CPU 100 is stored in the memory 200. The control program includes a display control program for switching the display mode of the first and second displays 11 and 21 between a two-screen display and a full-screen display, which will be described later.

In addition, the image data captured by the camera module 13, various kinds of data acquired from the outside through the communication module 304, and the like are stored in the memory 200 in predetermined file formats.

The CPU 100 operates the camera module 13, the microphone 35, the communication module 304, the liquid crystal panels 11a and 21a, the call speaker 38, the external speaker 308, and the like according to the control program based on operation input signals from the key input circuit 303 and the touch sensors 12 and 22. Accordingly, the CPU 100 executes various applications, such as a call application, an e-mail application, and a web browser.

In addition, the CPU 100 generates a launcher screen or an execution screen of various applications in the work area prepared in the memory 200 and outputs video signals for displaying these screens to the displays 11 and 21.

In addition, the CPU 100 determines which kind of operation is performed on the display surfaces 11c and 21c based on detection results of the touch sensors 12 and 22. For example, if a time for which inputs to the display surfaces 11c and 21 are detected is shorter than a certain specified time and there is no movement of input position, the CPU 100 determines that the display surfaces 11c and 21c have been tapped. If the input position moves by a predetermined distance (for example, 50 pixels) or more per unit time (for example, 50 ms) the CPU 100 determines that the display surfaces 11c and 21c have been flicked. If the input position has moved but the movement is less than a predetermined distance per unit time, the CPU 100 determines that the display surfaces 11c and 21c have been slid. Moreover, if a time for which inputs to the display surfaces 11c and 21c are detected is longer than a certain specified time (longer than the specified time in “tap”) and there is no movement of input position, the CPU 100 determines that the display surfaces 11c and 21c have been long-tapped.

<Function of a Mobile Phone>

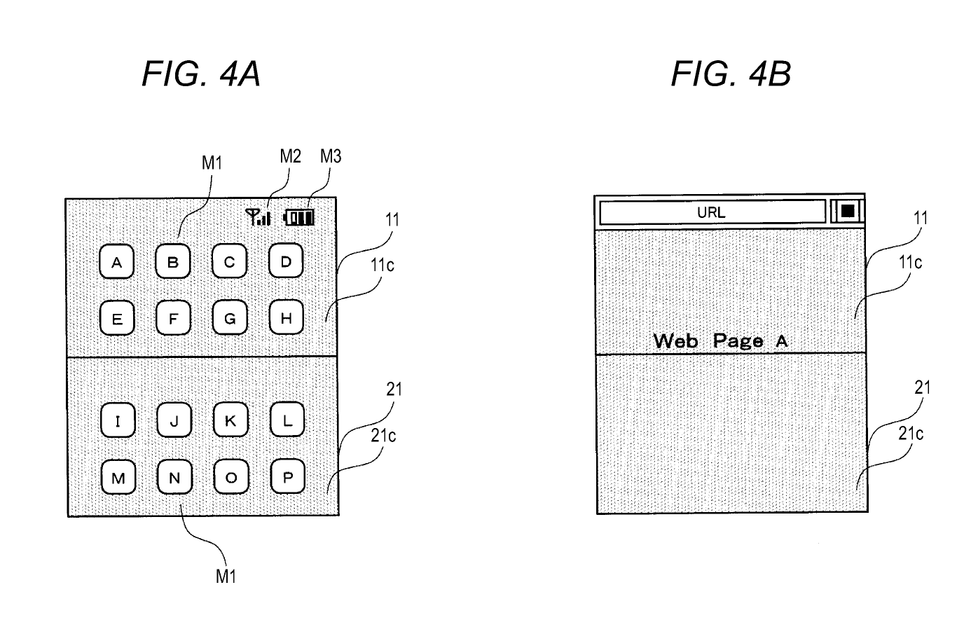

FIG. 4A is a view showing a state where a launcher screen is displayed on the first and second display surfaces 11c and 21c. FIG. 4B is a view showing a state where an execution screen of an application, which is started by an operation on the launcher screen, is displayed on the first and second display surfaces 11c and 21c.

As shown in FIG. 4A, icons M1 corresponding to various kinds of applications are displayed on the launcher screen. These applications may be installed in advance in the mobile phone 1 or may be acquired by downloading through the Internet and the like. The acquired application is added to the mobile phone 1 by installation.

In addition, an antenna mark M2 showing a signal receiving state and a battery power mark M3 showing the remaining power level of a battery are displayed on the launcher screen. The user can check the signal receiving state through the antenna mark M2 and can also check the remaining power level of the battery through by the battery power mark M3.

The user can start a desired application by tapping his or her finger or the like on the desired icon M1 among the plurality of icons M1.

An icon correspondence table, in which each icon M1 and the positions of each icon M1 on the first and second display surfaces 11c and 21c are matched with each other, and an application correspondence table, in which each icon M1 and each application are matched with each other, are stored in the memory 200. When the icon M1 is tapped, the CPU 100 specifies the tapped icon M1 based on the position using the icon correspondence table. In addition, using the application correspondence table, the CPU 100 specifies an application corresponding to the tapped icon M1 to start the application.

When the application is started, an execution screen for the application is displayed on the first and second display surfaces 11c and 21c. For example, when a web browser is started, a web page based on the URL is displayed on the first and second display surfaces 11c and 21c, as shown in FIG. 4B.

Here, when an execution screen of an application has a size corresponding to one display surface, the execution screen is displayed on either the first display surface 11c or the second display surface 21c. In this case, the launcher screen is kept being displayed on the other display surface, for example.

In addition, the user can start a new application while the application is being executed on the first and second display surfaces 11c and 21c. When the operation key 37 for displaying the launcher screen is pressed by the user, the launcher screen shown in FIG. 4A is displayed again while the current application is being executed in the background. When the new icon M1 is tapped on this launcher screen, a new application is started and the execution screen is displayed on the first and second display surfaces 11c and 21c. In this case, the previous application is in a temporary stop state (pause state) but is still running in the background.

On the other hand, in the present illustrative embodiment, a user can switch the display mode of the first and second displays 11 and 21 between a full-screen display (an example of a first mode) and a two-screen display (an example of a second mode).

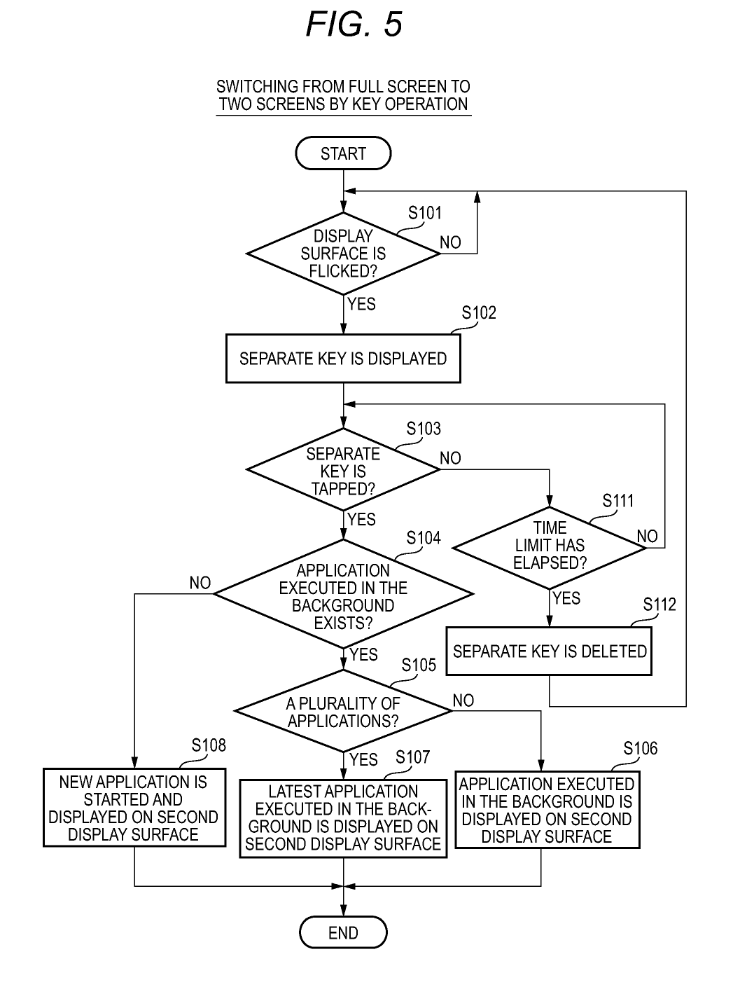

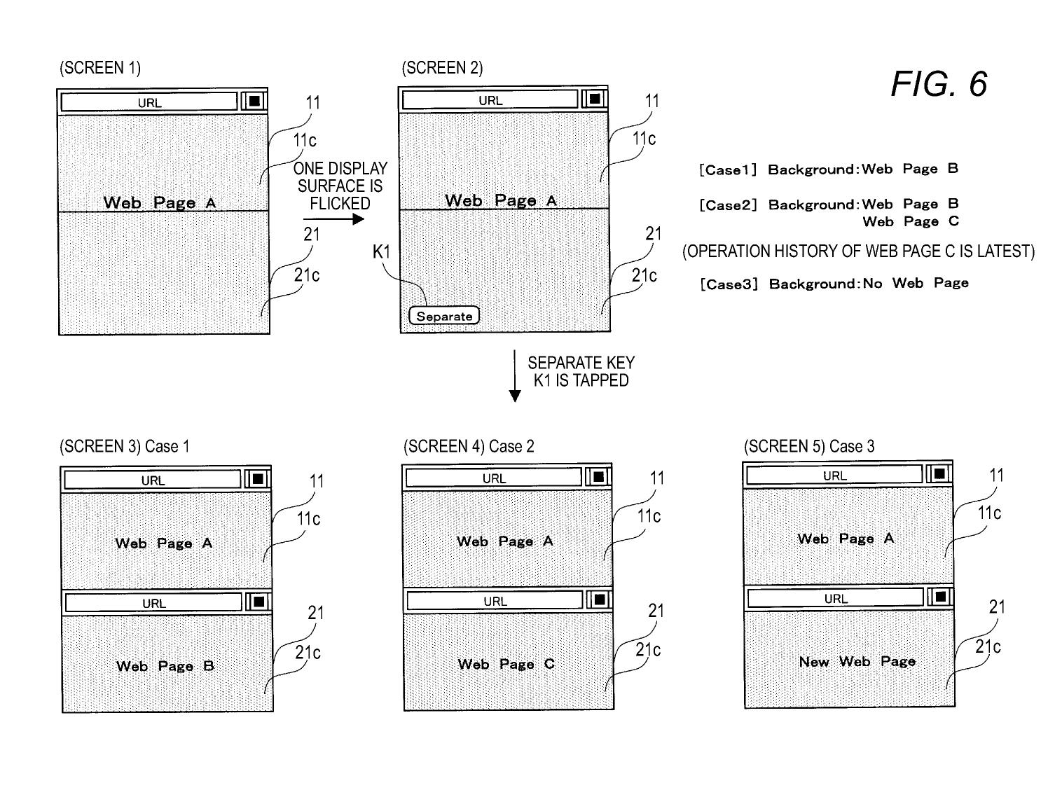

FIG. 5 is a flow chart showing the procedure of display control for switching the display mode from a full-screen display to a two-screen display. FIG. 6 is a view showing a transition state of screen display when the display control shown in FIG. 5 is executed.

When the display mode is a full-screen display, the display control shown in FIG. 5 is executed. Referring to FIG. 5, the CPU 100 monitors whether or not the first display surface 11c or the second display surface 21c has been flicked (S101).

As shown in (screen 1) of FIG. 6, when the user wants to switch display mode to a two-screen display from a full-screen display where an execution screen of a predetermined application, for example, a web page is displayed on both the first and second display surfaces 11c and 21c, the user flicks on one of the display surfaces.

When the first display surface 11c or the second display surface 21c is flicked (S101: YES), the CPU 100 displays a separate key K1 (an example of a key object) on the flicked display surface, as shown in (screen 2) of FIG. 6 (S102). Then, the CPU 100 monitors whether or not the separate key K1 has been tapped (S103).

The user taps on the separate key K1 in order to switch the display mode to the two-screen display. When the separate key K1 is tapped (S103: YES), the CPU 100 determines whether or not an application is being executed in the background (S104). Then, when it is determined that an application is being executed in the background (S104: YES), the CPU 100 determines whether or not a plurality of applications are being executed (S105).

When the number of applications executed in the background is one (S105: NO), the CPU 100 displays an execution screen of the application on the second display surface 21c (S106). For example, when a web browser which displays a web page different from the foreground is executed in the background, a web page displayed previously is displayed on the first display surface 11c and a new web page is displayed on the second display surface 21c, as shown in (screen 3) of FIG. 6.

On the other hand, when a plurality of applications are being executed in the background (S105: YES), the CPU 100 displays on the second display surface 21c an execution screen of an application related to a latest operation in an operation history including operations for starting applications (S107). For example, as shown in (screen 4) of FIG. 6, a web page displayed previously is displayed on the first display surface 11c, and a web page related to the latest operation in the operation history which has been prepared in the background is displayed on the second display surface 21c.

When the separate key K1 is tapped, no application may be executed in the background. When it is determined that there is no application executed in the background in step S104 (S104: NO), the CPU 100 newly starts a predetermined application and displays an execution screen of the newly started application on the second display surface 21c (S108).

For example, if the application executed previously is a multiply executable application which can be started concurrently multiple times, such as a web browser, the CPU 100 starts the same application and displays the execution screen on the second display surface 21c. For example, when a web page is opened previously as shown in (screen 1) of FIG. 6, a new web page based on the URL set in advance is opened and the web page is displayed on the second display surface 21c as shown in (screen 4) of FIG. 6. Herein, “multiple execution” means starting the same application as an application already executed.

Moreover, for example, if the application executed previously is an application which cannot be started concurrently multiple times, the CPU 100 starts an application set in advance, which is different from the application executed previously, and displays the execution screen on the second display surface 21c. In this case, an application functionally associated with the application executed previously, for example, an application of a phone directory is started if the application executed previously is an application of E-mail. In addition, when an application under a full-screen display cannot be started concurrently multiple times, the separate key K1 may not be displayed if there is no application executed in the background. Switching to a two-screen display may not be performed even if the separate key K1 is pressed.

When the separate key K1 is not tapped in step S103 (S103: NO), the CPU 100 determines whether or not a predetermined time limit (for example, 3 seconds) has elapsed (S111). When the time limit elapses in a state where the separate key K1 has not been tapped by the user (S111: YES), the CPU 100 deletes the separate key K1 from the display surface. Then, the process returns to step S101 to monitor flicking on the display surfaces 11c and 21c.

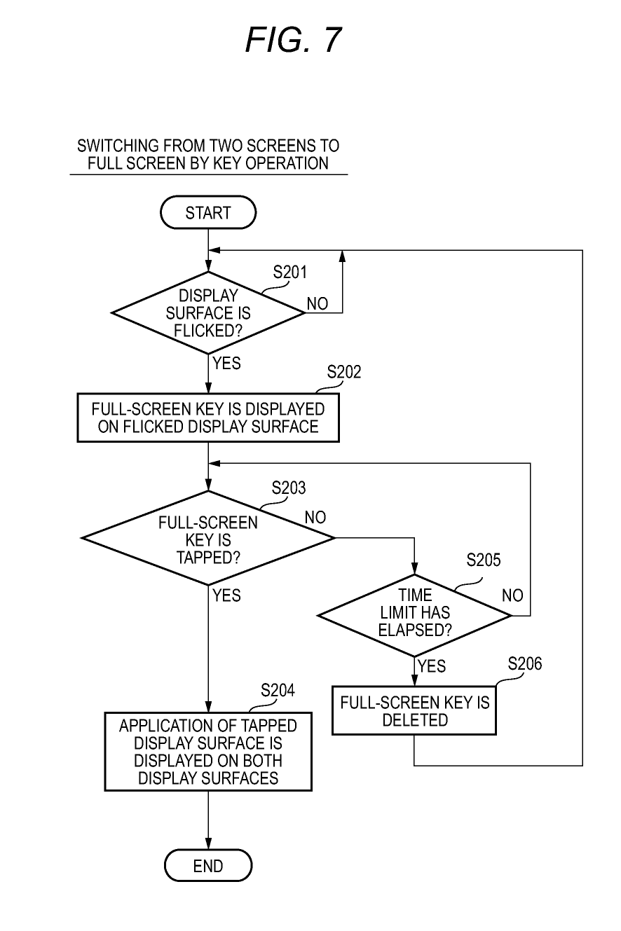

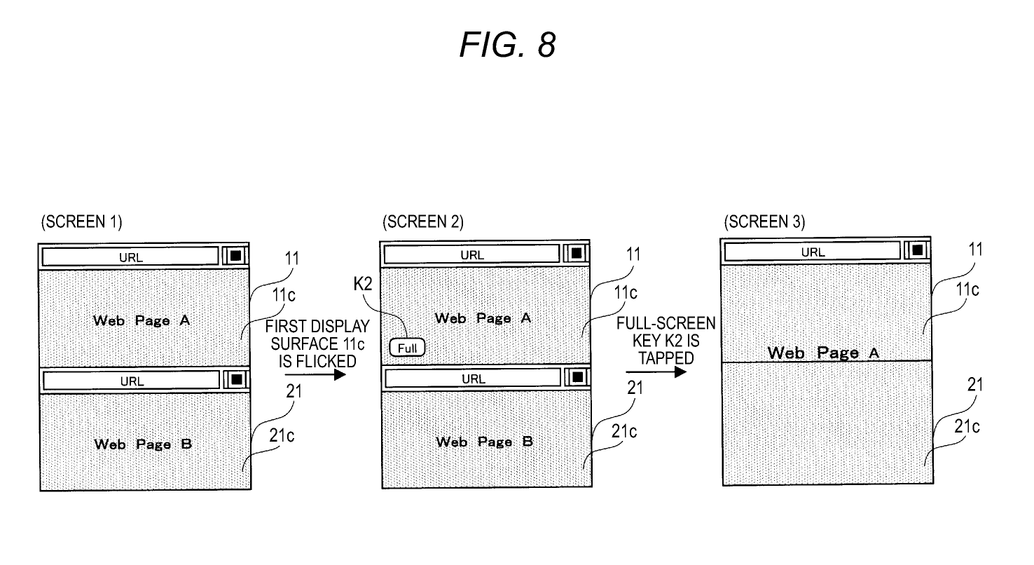

FIG. 7 is a flow chart showing the procedure of display control for switching the display mode from a two-screen display to a full-screen display. FIG. 8 is a view showing a transition state of screen display when the display control shown in FIG. 7 is executed.

When the display mode is a two-screen display, the display control shown in FIG. 7 is executed. Referring to FIG. 7, the CPU 100 monitors whether or not the first display surface 11c or the second display surface 21c has been flicked (S201).

As shown in (screen 1) of FIG. 8, when the user wants to switch the display mode to a full-screen display from a two-screen display where execution screens of two applications, for example, different web pages are respectively displayed on the first and second display surfaces 11c and 21c, the user flicks on the display surface on which an execution screen that is a target of the full-screen display is displayed.

When the first display surface 11c or the second display surface 21c is flicked (S201: YES), the CPU 100 displays a full-screen key K2 (an example of a key object) on the flicked display surface (S202). For example, when the first display surface 11c is flicked, a full-screen key K2 is displayed on the first display surface 11c, as shown in (screen 2) of FIG. 8.

The CPU 100 monitors whether or not the full-screen key K2 has been tapped (S203). When the full-screen key K2 is tapped by the user so that the display mode is switched to a full-screen display (S203: YES), the CPU 100 displays an execution screen of the application, which is displayed on the tapped display surface, on the first and second display surfaces 11c and 21c (S204). For example, when the full-screen key K2 displayed on the first display surface 11c is tapped, a web page displayed on the first display surface 11c is displayed on the first and second display surfaces 11c and 21c, as shown in (screen 3) of FIG. 8.

When the full-screen key K2 is not tapped in step 5203 (S203: NO), the CPU 100 determines whether or not a predetermined time limit (for example, 3 seconds) has elapsed (S205). When the time limit elapses in a state where the full-screen key K2 has not been tapped by the user (S205: YES), the CPU 100 deletes the full-screen key K2 from the display surface. Then, the process returns to step S201 to monitor flicking on the display surfaces 11c and 21c.

Next, in the present illustrative embodiment, when a hyperlink is set on the execution screen displayed on the first and second display surfaces 11c and 21c in a full-screen display after the mobile phone 1 is opened, the user can switch the display mode from a full-screen display to a two-screen display by an operation on an image (for example, a text, a picture, or a photograph) which is set with a hyperlink. Hereinafter, an image which is set with a hyperlink is called a “link image”.

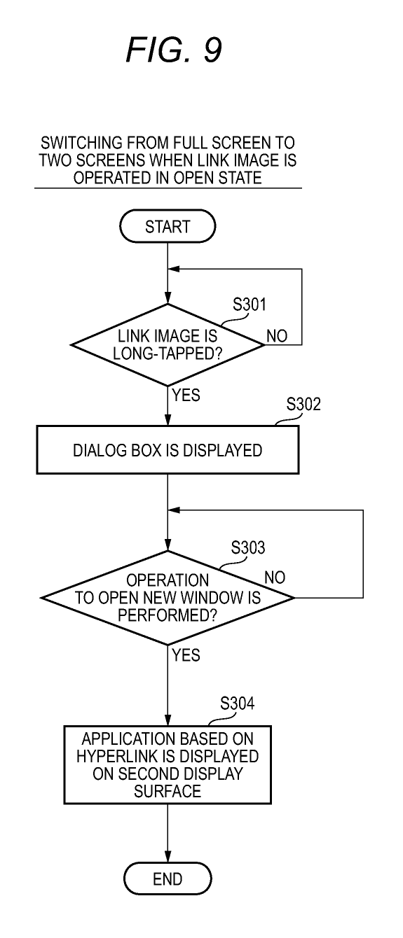

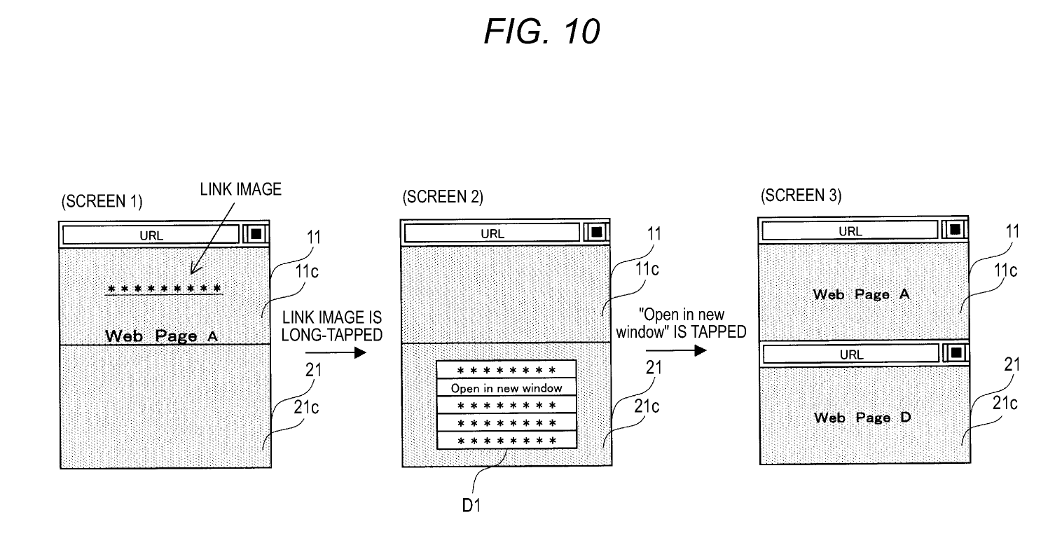

FIG. 9 is a flow chart showing the procedure of display control for switching the display mode from a full-screen display to a two-screen display based on an operation on a link image. FIG. 10 is a view showing a transition state of screen display when the display control shown in FIG. 9 is executed.

As shown in (screen 1) of FIG. 10, when a hyperlink is set on the execution screen displayed on the first and second display surfaces 11c and 21c, for example, on a web page, the CPU 100 detects whether or not the link image on the execution screen has been long-tapped (S301).

The user long-taps the link image when the user wants a two-screen display. When the link image is long-tapped (S301: YES), the CPU 100 displays a dialog box D1 on the second display surface 21c, as shown in (screen 2) of FIG. 10 (S302). A plurality of selections which the user can select are displayed in the dialog box D1. An item “Open in new window” is included in the selections. In addition, the dialog box D1 may also be displayed on the first display surface 11c.

The user selects the item “Open in new window” from the selections in the dialog box D1 and taps on it. Then, the CPU 100 determines that an operation to open a new window based on the hyperlink has been performed (S303: YES).

Information relevant to the hyperlink, such as a storage location of information to be referred to and an application to start, is stored in the memory 200. The CPU 100 starts an application based on the hyperlink by referring to the memory 200 and displays the execution screen on the second display surface 21c (S304). For example, when the hyperlink is referring to a new web page, a web browser is started and a web page based on the URL of the reference destination is opened and is displayed on the second display surface 21c, as shown in (screen 3) of FIG. 10. In this case, the web page displayed previously is kept being displayed on the first display surface 11c.

On the other hand, a user may use the mobile phone 1 in an open state or in a closed state depending on the circumstances of the moment. In the present illustrative embodiment, a display mode in an open state is held when the mobile phone 1 is closed, and a display mode when the mobile phone 1 was opened previously is used when the mobile phone 1 is opened again.

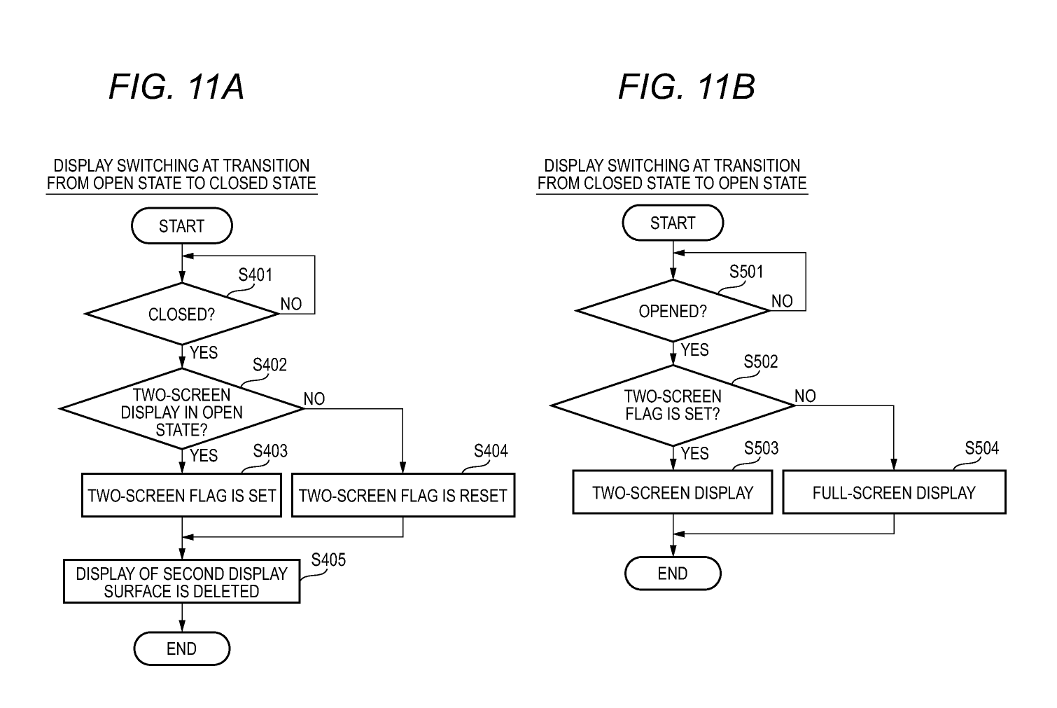

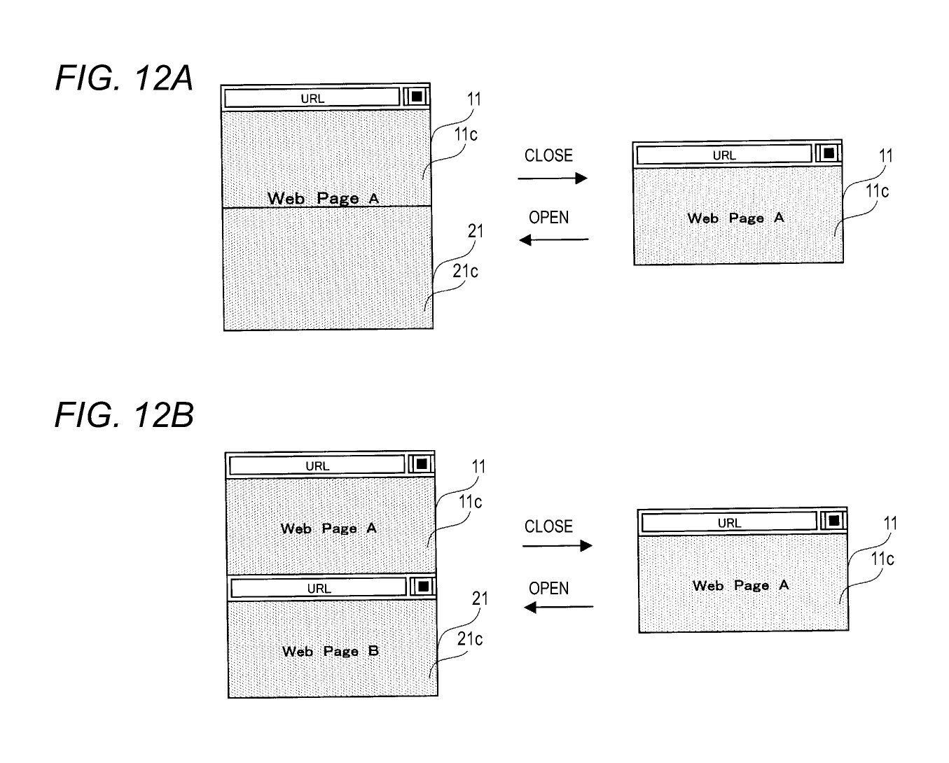

FIG. 11A is a flow chart showing a display switching control when the mobile phone 1 transitions from the open state to the closed state. FIG. 11B is a flow chart showing a display switching control when the mobile phone 1 transitions from the closed state to the open state. FIGS. 12A and 12B are views showing the transition state of screen display when the display switching control shown in FIGS. 11A and 11B is executed. FIG. 12A shows a screen display when the display mode of the mobile phone 1 is a full-screen display in the open state of the mobile phone 1. FIG. 12B shows a screen display when the display mode of the mobile phone 1 is a two-screen display in the closed state of the mobile phone 1.

Referring to FIG. 11A, when the mobile phone 1 is in the open state, the CPU 100 monitors whether or not the mobile phone 1 is closed (S401). When the mobile phone 1 is closed (S401: YES), the CPU 100 determines whether or not the display mode in the open state has been a two-screen display (S402). When the display mode in the open state is a two-screen display (S402: YES), the CPU 100 sets a two-screen flag (S403). When the display mode in the open state is a full-screen display (S402: NO), the CPU 100 resets the two-screen flag (S404). The two-screen flag is used to hold the display mode in the open state and is stored in the memory 200, for example.

Then, the CPU 100 turns off the second display 21 to delete the display of the second display surface 21c (S405). As a result, the execution screen of the application is displayed only on the first display surface 11c.

Referring to FIG. 11B, when the mobile phone 1 is in the closed state, the CPU 100 monitors whether or not the mobile phone 1 is opened (S501). When the mobile phone 1 is opened (S501: YES), the CPU 100 determines whether or not the two-screen flag is set (S502). When the two-screen flag is set (S502: YES), the CPU 100 sets the display mode in the open state as two-screen display (S503). When the two-screen flag is reset (S502: NO), the CPU 100 sets the display mode in the open state as full-screen display (S504).

In this way, when the mobile phone 1 is once closed and is then opened again, a full-screen display is performed again if the display mode in the previous open state is a full-screen display, as shown in FIG. 12A. On the other hand, as shown in FIG. 12B, a two-screen display is performed again if the display mode in the previous open state is a two-screen display.

Next, in the present illustrative embodiment, when a hyperlink is set on the execution screen displayed on the first display surface 11c in a state where the mobile phone 1 is closed, a user can switch the display mode in the open state at the time of switching from the closed state to the open state from a full-screen display to a two-screen display by an operation on the link image.

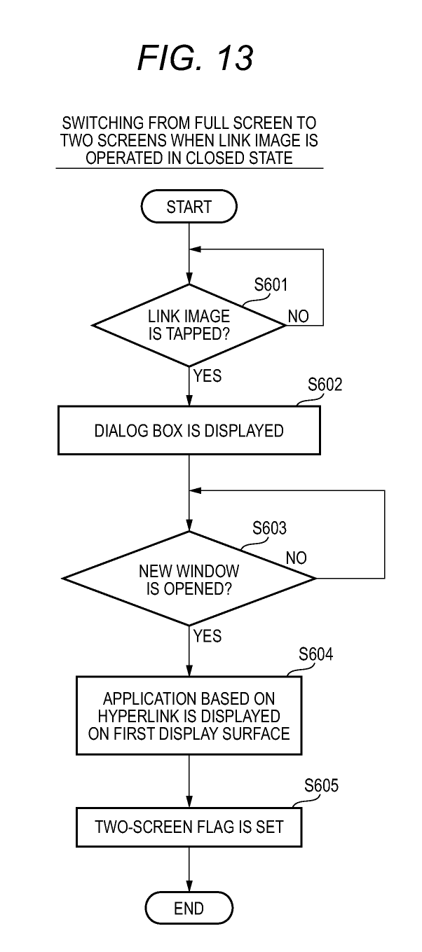

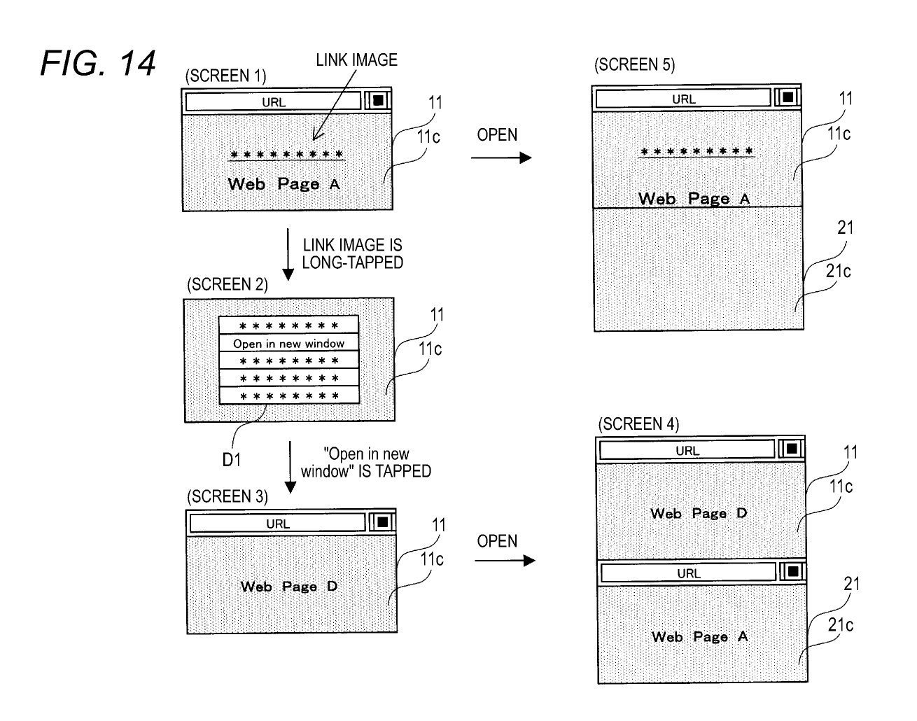

FIG. 13 is a flow chart showing the procedure of display control for switching the display mode from a full-screen display to a two-screen display based on an operation on a link image in a closed state. FIG. 14 is a view showing a transition state of screen display when the display control shown in FIG. 13 is executed.

As shown in (screen 1) of FIG. 14, when a hyperlink is set on an execution screen displayed on the first display surface 11c, for example, on a web page, the CPU 100 detects whether or not a link image on the execution screen has been long-tapped (S601).

When the link image is long-tapped (S601: YES) by the user, the CPU 100 displays a dialog box D1 on the second display surface 21c, as shown in (screen 2) of

FIG. 14 (S602). Then, when the item “Open in new window” is selected by the user, the CPU 100 determines that an operation to open a new window based on the hyperlink has been performed (S603: YES). Then, the CPU 100 starts an application based on the hyperlink and displays the execution screen on the first display surface 11c (S604). For example, when the hyperlink is referring to a new web page, a web browser is started and a web page based on the URL of the reference destination is opened and is displayed on the first display surface 11c, as shown in (screen 3) of FIG. 14. In addition, the application executed previously is kept being executed in the background.

Then, the CPU 100 sets a two-screen flag (S606). When the processing in FIG. 11B is executed in this state, two-screen display is performed when the mobile phone 1 is opened and the execution screen of the application executed in the background, for example, a web page is displayed on the second display surface 21c, as shown in (screen 4) of FIG. 14. In addition, when the mobile phone 1 is opened without operating the link image in the state of (screen 1) of FIG. 14, a full-screen display is performed, as shown in (screen 5) of FIG. 14.

### Effects of the Present Illustrative Embodiment

As described above, according to the present illustrative embodiment, a user can easily switch the display mode between a two-screen display and a full-screen display by operating the separate key K1 or the full-screen key K2.

In addition, according to the present illustrative embodiment, the full-screen key K2 is provided so as to correspond to each of the display surfaces 11c and 21c. Accordingly, the user can display a desired execution screen of the execution screens displayed on the display surfaces 11c and 21c by a two-screen display. In addition, since each full-screen key K2 is displayed on the corresponding display surfaces 11c and 21c, the user can easily see the correspondence between the display surfaces 11c and 21c and the full-screen key K2.

Moreover, according to the present illustrative embodiment, if there is no application executed in the background when the display mode switches from a full-screen display to a two-screen display, a new application is started and displayed on the second display surface 21c. Accordingly, the user does not need to start the new application when switching the display mode to a two-screen display.

In addition, according to the present illustrative embodiment, if there is a plurality of applications executed in the background when the display mode switches from a full-screen display to a two-screen display, an execution screen of an application related to a latest operation in an operation history is displayed on the second display surface 21c. Therefore, it is possible to display an execution screen of an application with a high possibility that the user will operate.

In addition, according to the present illustrative embodiment, when a hyperlink is set on the execution screen, the display mode is switched from a full-screen display to a two-screen display by performing a specific operation (long tap) on a link image, and an operation screen of an application based on the hyperlink is displayed on the second display surface 21c. Accordingly, when the user wants to display an original execution screen, on which a hyperlink is set, and an execution screen based on the hyperlink on the respective display surfaces 11c and 21c, the user does not need to perform an operation for switching to a two-screen display.

In addition, according to the present illustrative embodiment, the separate key K1 and the full-screen key K2 are first displayed by flicking on the display surfaces 11c and 21c. Accordingly, since the separate key K1 and the full-screen key K2 are displayed on the display surfaces 11c and 21c, a user's operation on the execution screen or viewing of the execution screen is not easily disturbed. In addition, the separate key K1 and the full-screen key K2 are not displayed just by touching the display surfaces 11c and 21c carelessly by the user. Accordingly, in order to display the separate key K1 and the full-screen key K2, the user needs to perform a clear operation of moving a finger or the like horizontally. For this reason, it is less likely for the separate key K1 and the full-screen key K2 to be displayed by an erroneous operation.

In addition, according to the present illustrative embodiment, the display mode in the open state is held even if the mobile phone 1 is closed. Accordingly, the user does not need to switch the display mode when the user opens the mobile phone 1 again.

### Other Illustrative Embodiments

While the present invention has been shown and described with reference to certain illustrative embodiments thereof, it will be understood by those skilled in the art that various changes in form and details may be made therein without departing from the spirit and scope of the invention as defined by the appended claims.

For example, in the illustrative embodiment described above, when a hyperlink is set on the execution screen, the display mode is switched from a full-screen display to a two-screen display by long tapping on a link image. However, in the case of a two-screen display, a hyperlink may also be set on the execution screen displayed on either of the display surfaces 11c and 21c. Accordingly, in this case, display control described below may be executed.

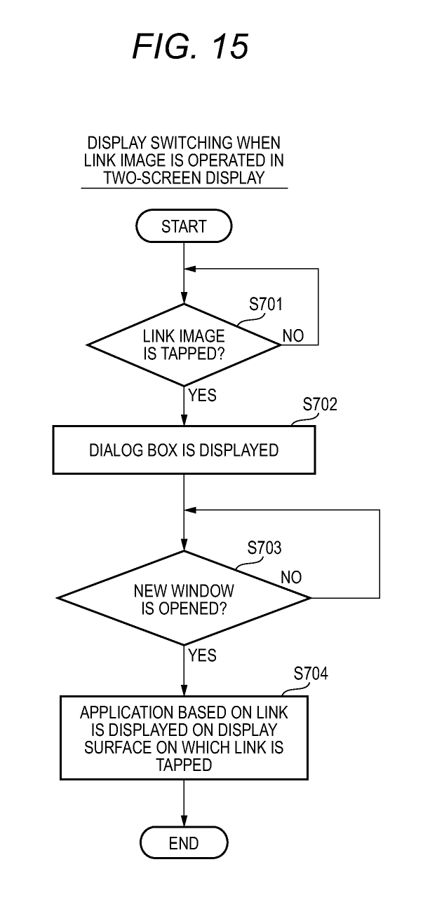

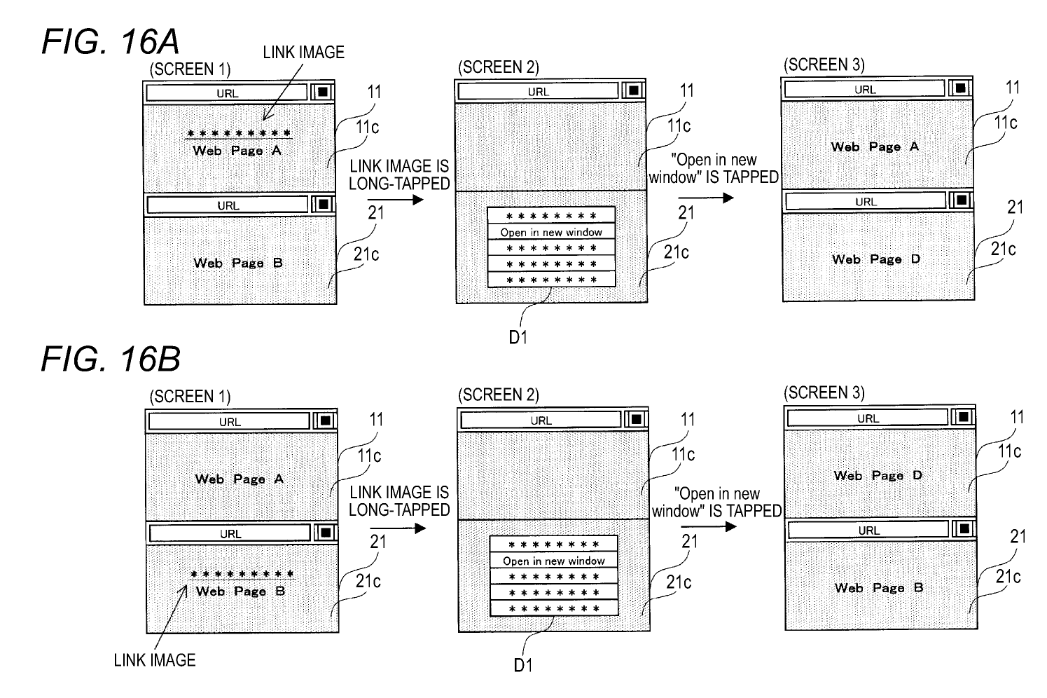

FIG. 15 is a flow chart showing display switching control when an operation on a link image is performed when the display mode is a two-screen display. FIGS. 16A and 16B are views showing the transition state of screen display when the display switching control shown in FIG. 15 is executed. FIG. 16A is a screen display when a link image of the execution screen displayed on the first display surface 11c is operated. FIG. 16B shows a screen display when a link image of the execution screen displayed on the second display surface 21c is operated.

Referring to FIG. 15, when a hyperlink is set on the execution screen displayed on the first display surface 11c or the second display surface 21c, for example, on a web page, the CPU 100 detects whether or not a link image has been long-tapped (S701).

When a link image displayed on either of the display surfaces 11c and 21c is long-tapped by the user (S701: YES), the CPU 100 displays a dialog box D1 on the second display surface 21c (S702). Then, when the item “Open in new window” is selected by the user, the CPU 100 determines that an operation to open a new window based on the hyperlink has been performed (S703: YES). Then, the CPU 100 starts an application based on the hyperlink and displays the execution screen on a different display surface from the display surface on which the execution screen with the long-tapped link image is displayed (S704).

In this way, when a link image of an execution screen displayed on the first display surface 11c is long-tapped as shown in (screen 1) of FIG. 16A, an execution screen of an application based on the hyperlink is displayed on the second display surface 21c as shown in (screen 3) of FIG. 16A. On the other hand, when a link image of an execution screen displayed on the second display surface 21c is long-tapped as shown in (screen 1) of FIG. 16B, an execution screen of an application based on the hyperlink is displayed on the first display surface 11c as shown in (screen 3) of FIG. 16B.

In addition, according to the present illustrative embodiment, a key object for switching the display mode of the first and second displays 11 and 21 is the separate key K1 and the full-screen key K2 displayed on the first and second display surfaces 11c and 21c, and tapped to so be operated. However, the key object may be operated by a hard key, such as the operation key 37.

In addition, in the illustrative embodiment described above, a display operation for displaying the separate key K1 and the full-screen key K2 on the display surfaces 11c and 21c is set as “flick”. However, the display operation is not limited thereto, and may be set as “slide” or “long tap”. In addition, the display operation may be set as “tap”. In this case, however, the possibility of an erroneous operation may be increased compared with flick, slide, and long tap. For this reason, as the display operation, an operation in which the input position on the display surfaces 11c and 21c moves, such as flick or slide, is preferable.

Moreover, in the illustrative embodiment described above, if there is no application executed in the background when the display mode switches from a full-screen display to a two-screen display, a new application is started and the execution screen of the application is displayed. However, when the display mode switches from a full-screen display to a two-screen display, a new application may always be started and the execution screen of the application may be displayed regardless of the existence of an application executed in the background.

In addition, in the illustrative embodiment described above, when the mobile phone 1 is closed and is then opened again, the display mode when the mobile phone 1 was in the open state previously is held. However, the present invention is not limited thereto, and the display mode may be switched to a mode set in advance when the mobile phone 1 is closed and is then opened again. For example, when the mobile phone 1 is opened again, the display mode may switch to a full-screen display regardless of whether the display mode before the mobile phone 1 is closed is a two-screen display or a full-screen display.

In addition, in the illustrative embodiment described above, the separate key K1 and the full-screen key K2 are displayed by flicking When a call or an e-mail arrives in a state where these keys K1 and K2 are displayed, the keys K1 and K2 are deleted and an arrival notification screen including arrival information, such as a telephone number, is displayed on the first and second display surfaces 11c and 21c. In this case, even if the separate key K1 and the full-screen key K2 are deleted, counting of the time limit is performed continuously. Accordingly, when the arrival notification ends and the first and second display surfaces 11c and 21c return to the original screens, the separate key K1 and the full-screen key K2 are deleted if the time limit elapses.

Without being limited thereto, when the first and second display surfaces 11c and 21c return to the original screens, the separate key K1 and the full-screen key K2 may necessarily be displayed by stopping the counting of the time limit during the arrival notification or by resetting the time limit when there is a call or an e-mail. In addition, it is preferable to display the same arrival notification screen on both the first and second display surfaces 11c and 21c during the arrival notification.

In addition, in the illustrative embodiment described above, there is a case where the mobile phone 1 is closed when the separate key K1 is displayed on the first display surface 11c or the second display surface 21c in the open state of the mobile phone 1. In this case, since the display mode does not switch to a two-screen display any longer, the CPU 100 may delete an image of the separate key K1. Similarly, there is a case where the mobile phone 1 is closed when the full-screen key K2 is displayed on the first display surface 11c or the second display surface 21c in the open state of the mobile phone 1. In this case, since the display mode does not switch to a full-screen display any longer, the CPU 100 may delete an image of the full-screen key K2.

In addition, although the web browser has been described as an example of an application in the above illustrative embodiment, display mode switching between a full-screen display and a two-screen display may also be performed on execution screens of other applications, such as an e-mail application, an address book application, and an application for video reproduction.

In addition, the mobile terminal apparatus of the present invention is not limited to the mobile phone, and may be a PDA (Personal Digital Assistant), a tablet PC, and the like.

What is claimed is:

1. A mobile terminal apparatus comprising:
a first display section;
a second display section aligned with the first display section; and
a control section configured to control display of the first and second display sections,
wherein the control section is configured to display, on at least one of the first and second display sections, a key object to switch a display mode of the first and second display sections,
wherein the control section is configured to switch the display mode between a first mode where an execution screen for one application is displayed on the first and second display sections and a second mode where an execution screen for one of two applications is displayed on the first display section and an execution screen for the other of the two applications is displayed on the second display section, based on an operation to the key object.

2. The mobile terminal apparatus according to claim 1,
wherein the key object includes a first key object corresponding to the first display section and a second key object corresponding to the second display section,
wherein when the first key object is operated in a state where the display mode is the second mode, the control section is configured to display on the first and second display sections an execution screen for an application whose execution screen has been displayed on the first display section in the second mode, and
wherein when the second key object is operated in a state where the display mode is the second mode, the control section is configured to display on the first and second display sections an execution screen for an application whose execution screen has been displayed on the second display section in the second mode.

3. The mobile terminal apparatus according to claim 1,
wherein when the key object is operated for switching from the first mode to the second mode, the control section is configured to display on the second display section an execution screen for an application executed in a background.

4. The mobile terminal apparatus according to claim 3,
wherein when the key object is operated for switching from the first mode to the second mode, the control section is configured to start a pre-set application and displays on the second display section an execution screen for the started pre-set application if no application is executed in the background.

5. The mobile terminal apparatus according to claim 3,
wherein when the key object is operated for switching from the first mode to the second mode, the control section is configured to display on the second display section an execution screen for an application which is related to a latest operation in an operation history if a plurality of applications are executed in the background.

6. The mobile terminal apparatus according to claim 1, further comprising:
a detection section configured to detect an input on the first and second display sections,
wherein the detection section is configured to detect an input corresponding to an operation to the key object displayed on the at least one of the first and second display sections.

7. The mobile terminal apparatus according to claim 6,
wherein the control section is configured to display the key object when the detection section detects an input corresponding to a predetermined display operation in a state where the key object is not displayed.

8. The mobile terminal apparatus according to claim 7,
wherein when the detection section detects a movement of an input position, the control section is configured to display the key object as determining that the predetermined display operation is detected.

9. The mobile terminal apparatus according to claim 6,
wherein in a state where a hyperlink is set on an execution screen for an application displayed on the first and second display sections in the first mode, the control section is configured to switch the display mode from the first mode to the second mode and display on the second display section an execution screen for an application started based on the hyperlink when the detection section detects an input corresponding to an operation on the hyperlink.

10. The mobile terminal apparatus according to claim 1, further comprising:
a changing section configured to change between a first state where one of the first and second display sections is exposed to an outside and a second state where both the first and second display sections are exposed to the outside,
wherein the control section is configured to delete the key object when the second state is changed into the first state in a state where the key object is displayed.

11. The mobile terminal apparatus according to claim 1, further comprising:
a changing section configured to change between a first state where one of the first and second display sections is exposed to an outside and a second state where both the first and second display sections are exposed to the outside; and
a storage section,
wherein the control section is configured to store the display mode at the time of the second state in the storage section when the second state is changed into the first state, and configured to control the first and second display sections to become the display mode stored in the storage section when the first state is changed into the second state.

12. A non-transitory computer-readable medium having a computer program stored thereon and readable by a computer of a mobile terminal apparatus including a first display section and a second display section aligned with the first display section, the computer program, when executed by the computer, causing the computer to perform operations comprising:
displaying a key object to switch a display mode of the first and second display sections; and
switching the display mode between a first mode where an execution screen for one application is displayed on the first and second display sections and a second mode where an execution screen for one of two applications is displayed on the first display section and an execution screen for the other of the two applications is displayed on the second display section, based on an operation to the key object.

13. A method for controlling a mobile terminal apparatus including a first display section and a second display section aligned with the first display section, the method comprising:
displaying a key object to switch a display mode of the first and second display sections; and
switching the display mode between a first mode where an execution screen for one application is displayed on the first and second display sections and a second mode where an execution screen for one of two applications is displayed on the first display section and an execution screen for the other of the two applications is displayed on the second display section, based on an operation to the key object.
